(19) United States
(12) Patent Application Publication
(10) Pub. No.: US 2008/0310274 A1
(43) Pub. Date: Dec. 18, 2008

(54) Radial Tilt Estimation Via Diagonal Push-Pull

(75) Inventor: Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,800

(22) PCT Filed: Dec. 4, 2006
(86) PCT No.: PCT/IB2006/054566

§ 371 Date: Jun. 10, 2008

(30) Foreign Application Priority Data
Dec. 13, 2005 (EP) 05301047.6

(51) Int. Cl. G11B 7/00

(52) U.S. Cl. 369/53.19; G9B/7

(57) ABSTRACT

A device is arranged for scanning an optical record carrier (11), which has a data layer with parallel data tracks. The device has an optical head (22) comprising a detector for receiving radiation reflected from a data track, the detector having sub-detectors arranged in a quadrant. The device has a tilt unit (32) for generating a tilt signal representing a tilt angle (204) between an optical axis (202) of the optical head and a perpendicular (203) of the data layer. The tilt unit (32) generates a diagonal push-pull signal based on a difference of a first signal of a first diagonally positioned pair of sub detectors and second signal of a second diagonally positioned pair of sub detectors, and processes the diagonal push-pull signal for generating the tilt signal.

### FIELD OF THE INVENTION

The invention relates device for scanning an optical record carrier, the record carrier comprising a data layer having substantially parallel data tracks, the device comprising an optical head comprising a detector for receiving radiation reflected from a data track, the detector having sub-detectors arranged in a quadrant aligned in a direction corresponding to the track direction, and tilt means for generating a tilt signal representing a tilt angle between an optical axis of the optical head and a perpendicular of the data layer.

The invention further relates to a method of detecting tilt while scanning an optical record carrier, the record carrier comprising a data layer having substantially parallel data tracks, the method comprising generating a tilt signal representing a tilt angle between an optical axis of the optical head and a perpendicular of the data layer based on radiation reflected from a data track received on sub-detectors arranged in a quadrant aligned in a direction corresponding to the track direction.

### BACKGROUND OF THE INVENTION

In optical drives, the read-out performance is often degraded by tilt. Tilt is the angle between an optical axis of the optical head and a perpendicular of the data layer of the record carrier. Two types of tilt exist, called tangential tilt and radial tilt. With tangential tilt the spot is tilted in the track direction, which distorts the optical channel and causes severe inter-symbol interferences (ISI). With radial tilt the spot is tilted towards the neighbouring tracks, in which the neighbouring track data enter the target track read-out in the form of inter-track interference (ITI) or cross talk (XT). In order to increase the robustness of optical drives against tilt, a tilt estimator is needed with which the tilt can be corrected in either a mechanical or signal processing way.

A device and method for scanning an optical record carrier and detecting tilt are known from the document “New radial tilt detection method using only one beam and one four-quadrant detector” by Y. Wang et al. Japanese Journal of Applied Physics, Vol. 43, No. 11A, 2004, pp 7513-7518 (called doc1). In doc1 a four quadrant detector, having four sub-detectors denominated A, B, C and D, is used to generate a tilt error signal. The effects of disk radial tilt on a differential time detection (DTD) tracking error signal (TE) are calculated and measured. The method uses the difference between the offsets of two tracking methods due to tilt. The first tracking signal is the DTD signal, based on the time difference of the signal A+C and the signal B+D, illustrated by the formula DTDTE=τ_{(A+C)}−τ_{(B+D)}. A second tracking error signal (TE) is based on a push-pull signal (PP) of the two detector halves A+B and C+D, illustrated by the formula PPTE=(A+B−C−D). The difference between the two tracking methods is analyzed and used to calculate a tilt signal representing the tilt angle.

However, the quality of the push-pull signal is in general lower than the quality of the DTD signal. Hence the tilt signal may be inaccurate and unreliable.

### SUMMARY OF THE INVENTION

Therefore it is an object of the invention to provide a device and method for generating a reliable tilt signal.

According to a first aspect of the invention the object is achieved with a device as described in the opening paragraph, the tilt means being arranged for generating a diagonal push-pull signal based on a difference of a first signal of a first diagonally positioned pair of sub detectors and second signal of a second diagonally positioned pair of sub detectors, and processing the diagonal push-pull signal for generating the tilt signal.

According to a second aspect of the invention the object is achieved with a method as described in the opening paragraph, which method comprises generating a diagonal push-pull signal based on a difference of a first signal of a first diagonally positioned pair of sub detectors and second signal of a second diagonally positioned pair of sub detectors, and processing the diagonal push-pull signal for generating the tilt signal.

The effect of the measures is that the diagonal push-pull signal is generated as a single combined signal. Advantageously the diagonal push-pull signal comprises substantial signal elements representing the tilt angle. By processing the diagonal push-pull signal the tilt signal is generated.

The invention is also based on the following recognition. There are a few important requirements for a good tilt estimator. First, a tilt estimator should be able to detect the tilt on the fly during reading because in such a manner it enables a dynamic tilt correction that is necessary for achieving good drive playability. Secondly, use of extra optical components is not preferred, such as additional gratings for generating satellite spots or a second laser being active simultaneously with the main laser in a dual-wavelength method. Finally, the tilt estimation result, as a function of the tilt angle, must have a wide enough linear range (including sign) and high enough sensitivity around the nominal point (zero tilt) that can ease the proper working of the tilt correction.

Known methods, like method based on jitter value, push-pull (like doc1 discussed above) or high frequency read signal (RF) amplitude based, cannot reliably detect tilt angle and/or tilt sign. Only part of the above requirements is met with existing methods. The problems mainly lie on that extra optical components have to be used, which increases the cost and introduces possible instability to the system, and that the estimation is static (e.g. in a special tilt detection procedure) and can not be done on the fly (during scanning the data tracks, e.g. for reading data).

The inventors have seen that from available optical elements and detectors, the diagonal push-pull signal is generated easily in the high frequency domain based on the sub-detector signals without requiring further filtering or time detection. Advantageously, the diagonal push-pull signal contains signal elements corresponding to the radial tilt. A tilt signal is conveniently generated by processing the diagonal push-pull signal, e.g. by an appropriate filter, while assuming that scanning spot is centered on the track by a tracking servo system.

In an embodiment of the device the tilt means are arranged for generating a channel data signal based on data from the data track and a channel response of a diagonal push-pull channel, and for processing the diagonal push-pull signal by cross-correlating the diagonal push-pull signal and the channel data signal for generating the tilt signal. The channel data signal represents the signal of an ideal diagonal push-pull channel, i.e. a signal based on the data marks in the track and the response of the elements constituting the diagonal push-pull channel. Cross-correlating the channel data signal with the diagonal push-pull signal has the advantage that the signal elements representing tilt are magnified.

In an embodiment of the device the tilt means comprise discrimination means for generating a difference signal for discriminating a tracking offset from a tilt based on a diagonal push-pull signal cross-correlated with a data read signal convolved with a first filter having a first impulse response based on the channel response of the diagonal push-pull channel in the event of tilt, and the diagonal push-pull signal cross-correlated with a data read signal convolved with a second filter having a second impulse response based on the channel response of the diagonal push-pull channel in the event of tracking offset. Using both filters has the advantage that the difference signal is generated from the same detector signals that are used for generating the tilt signal. If the difference signal indicates a tracking offset, the device may first correct the tracking offset. Hence it is prevented that tracking offset disturbs the tilt detection.

Further preferred embodiments of the device and method according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows track scanning of a laser spot deformed by radial tilt,

FIG. 2 shows diffraction orders on a photo detector,

FIG. 3 shows a scanning device with tilt detection,

FIG. 4 shows diagonal push-pull channel symbol responses in the presence of radial tilt,

FIG. 5 shows a tilt signal generating device, and

FIG. 6 shows radial tilt estimation results.

FIG. 7 shows a process of detecting tilt.

In the Figures, elements which correspond to elements already described have the same reference numerals.

### DESCRIPTION OF THE PREFERRED EMBODIMENTS

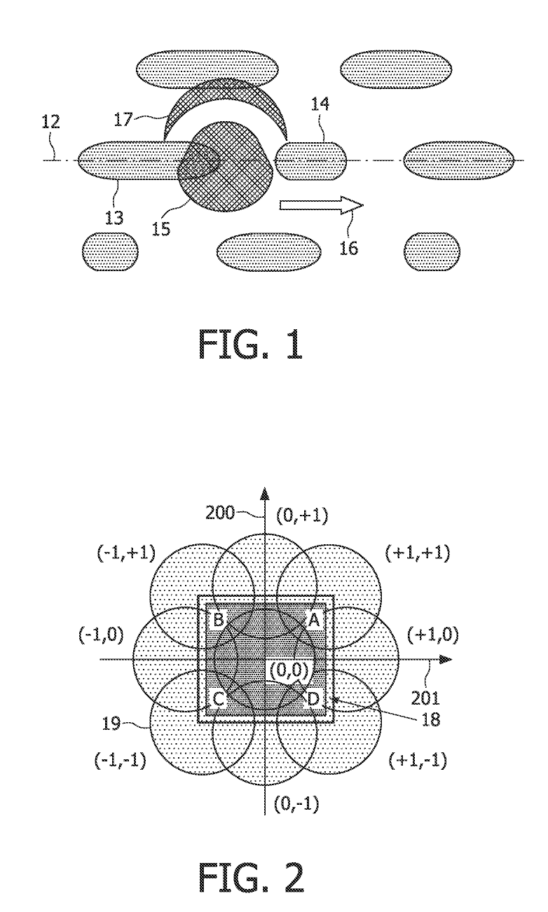

FIG. 1 shows track scanning of a laser spot deformed by radial tilt. The Figure schematically shows a track 12 that is scanned by a spot 15 in a direction along the track indicated by arrow 16. The track contains optical marks 13,14, e.g. pits and lands on an optical record carrier like DVD (Digital Versatile Disc), or BD (Blu-ray Disc). The laser spot 15 is deformed by radial tilt and has further radiation 17 incident partly on a neighbouring track. The spot 15 is scanning along the track, where a tracking servo keeps the spot on track. Tracking servo systems are well known in optical recording, for example a push-pull-based tracking method. In (re)writable optical disc systems, usually a 3-spot push pull tracking system is applied. For the sake of simplicity, satellite spots are not depicted here. The push-pull method balances the light intensities on two halves of a photo detector and as a result the centre of the “mass” of the spot is kept on the target track.

FIG. 2 shows diffraction orders on a photo detector. The Figure shows a photo detector 18 having four sub-detectors marked A, B, C and D arranged in a quadrant. The sub-detectors are aligned with the track direction as indicated with arrow 200, whereas the radial direction is indicated with arrow 201. On the detector a pattern of radiation is shown according to the diffraction orders of the reflected radiation from the scanning spot 15 on the track 12. The diffraction orders are marked according to the respective orders, e.g. (0,0), (−1,+1), etc.

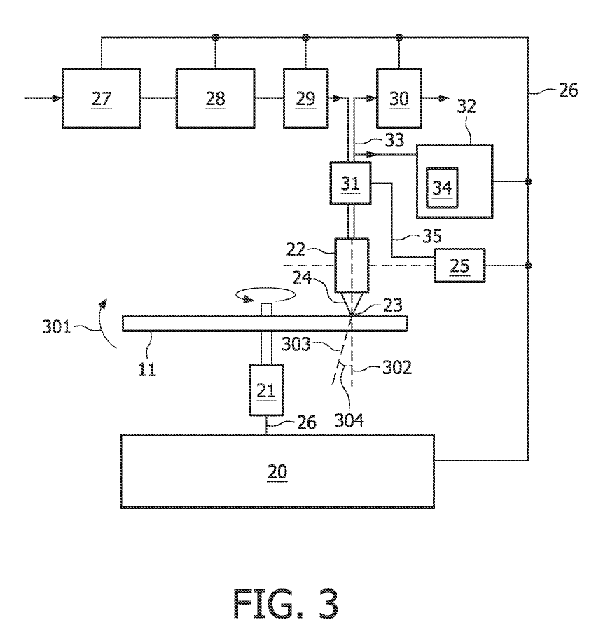

FIG. 3 shows a scanning device with tilt detection. The device is provided with scanning means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25.

The record carrier 11 may exhibit a tilt as schematically indicated by arrow 301. For example the tilt may result from a non-flat surface, a non perfect mechanical support, or scanning system offset, etc. A tilt angle 304 is defined at the position of the scanning spot 23, as the angle between an optical axis 302 of the head 22 and a perpendicular 303 of data layer of the record carrier. Note that in practice the tilt angle is about 1 degree or less, and the Figure is not drawn to scale.

The head, or the record carrier support system, may further include tilt actuators for adapting a tilt angle between a perpendicular to the data layer and an optical axis of the optical system of the head. The tilt actuators may be controlled based on the tilt signal generated as discussed below.

During reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information. The control unit 20 comprises control circuitry, for example a microprocessor, a program memory and control gates. The control unit 20 may also be implemented as a state machine in logic circuits.

The device may be provided with recording means for recording information on a record carrier of a writable or re-writable type. The recording means comprise an input unit 27, a formatter 28 and a laser unit 29 and cooperate with the head 22 and front-end unit 31 for generating a write beam of radiation. The formatter 28 is for adding control data and formatting and encoding the data according to the recording format, e.g. by adding error correction codes (ECC), synchronizing patterns, interleaving and channel coding. The formatted data comprise address information and are written to corresponding addressable locations on the record carrier under the control of control unit 20. The formatted data from the output of the formatter 28 is passed to the laser unit 29 which drives the laser and controls the laser power for writing the marks in a selected layer.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN16452), and for video in the MPEG2 standard. The input unit 27 processes the audio and/or video to units of information, which are passed to the formatter 28. The read processing unit 30 may comprise suitable audio and/or video decoding units.

The device has a tilt detection unit 32 for detecting a tilt and, in dependence thereon, generating a tilt signal based on a diagonal push-pull signal. The tilt signal may be coupled to the servo unit 25, providing a tilt error signal for adjusting the tilt servo. Alternatively, or additionally, the tilt signal may be used elsewhere, e.g. to adjust a recording process or to adapt the processing of the read signal in read unit 30, e.g. by compensating an amount of inter track cross-talk which is related to the amount of tilt represented by the tilt signal. The tilt signal is determined as discussed in detail below with reference to FIGS. 1, 2 and 4-6. The tilt detection unit 32 may also be implemented as a software function in the control unit 20, using the front end unit 31, and the read circuitry in read unit 30, for providing selected sub-detector signals for generating the diagonal push-pull signal. The tilt detection unit 32 may be provided with a tilt discrimination unit 34 for discriminating a tilt error from a tracking error by processing the diagonal push-pull signal applying a filter for identifying tracking offset elements in the diagonal push-pull signal.

As can be seen in FIG. 1, due to the deformation of the spot 15 resulting from tilt, the scanning spot meets the upper and lower edges of each mark 13,14 differently in time, resulting in a difference of light intensity variation between two diagonal diffraction pairs, i.e., (+1, +1) and (−1, −1), (−1, +1) and (+1, −1). The diffraction orders are induced by the said edges of the marks in FIG. 1 and depicted in FIG. 2.

Based on the signals from each sub-detector a diagonal push-pull (DPP) signal is generated based on a difference of a first signal of a first diagonally positioned pair of sub detectors and second signal of a second diagonally positioned pair of sub detectors. The signal indicative of tilt can be detected from the diagonal push-pull signal.

Diagonally positioned pairs with respect to the center of the detector, i.e. the crossing of both arrows 200,201, are pairs A,C and B,D. Note that different shape and ordering of the sub-detectors may also be used. The diagonal push-pull signal contains tilt signal elements related to the deformed shape of the scanning spot, which is caused by the tilt. The diagonal push-pull signal is subsequently processed to isolate the tilt signal elements for generating the tilt signal, as explained further below. The diagonal push-pull signal may be based on the formula

Iₖ^{(DPP)}=Iₖ^{(A)}+Iₖ^{(C)}−Iₖ^{(B)}−Iₖ^{(D)} (1)

where Iₖ^{(X)} (X=A, B, C and D) denotes a radiation intensity on each sub-detector as a function of scanning position or time instant k, the first signal of the first diagonally positioned pair of sub detectors A,C being denoted by Iₖ^{(PP1)}=Iₖ^{(A)}+Iₖ^{(C)}, and the second signal of the second diagonally positioned pair of sub detectors B,D being denoted by Iₖ^{(PP2)}=Iₖ^{(D)}+Iₖ^{(B)}.

In a nominal situation where the spot 15 is perfectly symmetric in radial direction, the diagonal push-pull signal Iₖ^{(DPP)} is zero, implying that no light intensity variation difference exists between A, C and B, D; while with radial tilt, the resultant Iₖ^{(DPP)} becomes nonzero. For the sake of simplicity, we assume the channel is free of non-linearity and noise. Then one can write the DPP channel readout signal as follows:

Cₖ^{(DPP)}=(a*h^{(DPP)})ₖ (2)

where aₖ represents the channel data sequence (alphabet {−1, 1}), hₖ^{(DPP)} the DPP channel symbol response (CSR) of the diagonal push-pull channel and * a linear convolution.

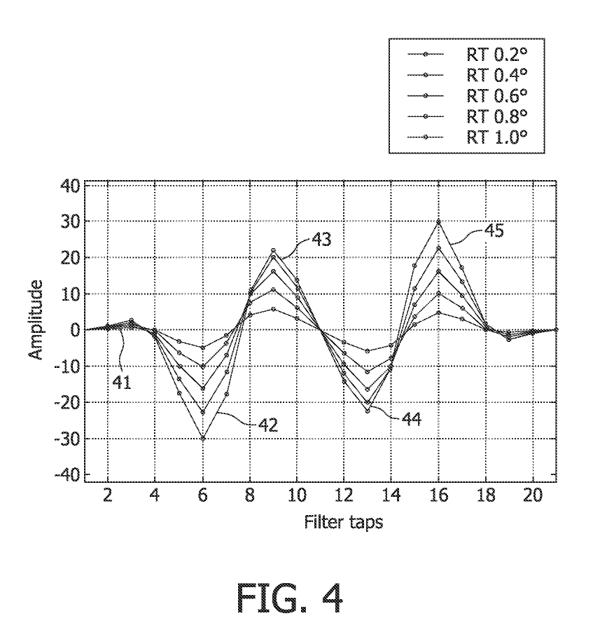

FIG. 4 shows DPP channel symbol responses in the presence of radial tilt. The amplitude of the response is indicated on the vertical axis, and the response is represented at filter taps of a finite impulse response (FIR) filter.

A set of curves 41 provides examples of hₖ^{(DPP)} at various radial tilt (RT) angles. The examples are based on scalar diffraction with a Blu-ray Disc set-up at 25 GB capacity. The curves are in general anti-symmetric around origin and tap amplitude increases with the tile angle θ. To a first order approximation, formula (2) can be rewritten as:

Iₖ^{(DPP)}(θ)≈θ×(a*h^{(DPP)})ₖ (3)

In reality, the signal Iₖ^{(DPP)}(θ) suffers from noise and may get nonzero due to other light path imperfections that are irrelevant to radial tilt. Hence, (3) can be generalized to:

$$\begin{matrix}{I}_{k}^{( DPP )} = {I}_{k}^{( DPP )} ( θ ) + Δ {I}_{k}^{( DPP )} + {n}_{k} \\ = θ \times {( a * {h}^{( DPP )} )}_{k} + {( a * Δ {h}^{( DPP )} )}_{k} + {n}_{k}\end{matrix} \qquad ( 4 )$$

To extract the information of radial tilt θ, one needs ideally cross-correlate Iₖ^{(DPP)}(θ) with (a*h^{(DPP)})ₖ to get the tilt estimate:

$${χ}_{θ} = {\sum }_{k} ( {( a * {h}^{( DPP )} )}_{k} \times {I}_{k}^{( DPP )} ) \qquad ( 5 )$$

In principle, hₖ^{(DPP)} is not exactly known in the receiver. However, we can produce a rough version of (a*h^{(DPP)})ₖ by convolving the estimated bit sequence âₖ with an FIR filter, whose impulse response sₖ is a stylized approximation of hₖ^{(DPP)}, e.g., sₖ=[1, 0, 0, 1, 0, 0, 0−1, 0, 0, 1] for 25 GB. Then, (5) becomes:

$${χ}_{θ} = {\sum }_{k} ( {( \hat{a} * s )}_{k} \times {I}_{k}^{( DPP )} ) \qquad ( 6 )$$

Moreover, it is also preferably not to use bit estimate âₖ explicitly to avoid the deterioration of tilt estimation due to bit errors as well as speed limitation due to a delay between Iₖ^{(DPP)} and reconstructed âₖ in the possible use of a tilt corrector. For this reason, one can consider to replace âₖ in (6) with its synchronous central aperture signal Iₖ^{(CA)} that is always immediately available, according to the formula:

$${χ}_{θ} = {\sum }_{k} ( {( {I}^{( CA )} * s )}_{k} \times {I}_{k}^{( DPP )} ) \qquad ( 7 )$$

Compared to âₖ, Iₖ^{(CA)} takes some extra disturbances into estimation, like noise, cross talk and ISI. Cross talk impact can be limited to certain extent by the nature of cross-correlation assuming the cross talk appearance in Iₖ^{(DPP)} is much weaker than that of the target track data. ISI will not give any influence as long as the central aperture channel symbol response keeps symmetric, which is the case with radial tilt, as well as constant, which is roughly true within the radial tilt range of interest ([−1°, 1°]).

For good and stable radial tilt estimation, the term Δh^{(DPP)} in (4) caused by other light path imperfections should ideally be orthogonal to the selected signature filter sₖ, which is in fact the case with normally considered aberrations like tangential tilt, defocus and spherical aberration.

A tracking offset will cause an anti-symmetric DPP CSR, but the middle two lobes 43,44 have much higher amplitude than two outer lobes 42,45 shown in FIG. 4. Therefore, specific checking filters can be designed for helping to distinguish between radial tilts and tracking offsets before actual estimation. For example, a tilt discrimination signal Δχ may be defined as follows:

$$Δχ = \vert \vert {\sum }_{k} ( {( {I}^{( CA )} * {s}^{( O )} )}_{k} \times {I}_{k}^{( DPP )} ) \vert - \vert {\sum }_{k} ( {( {I}^{( CA )} * {s}^{( M )} )}_{k} \times {I}_{k}^{( DPP )} ) \vert \vert \qquad ( 8 )$$

where sₖ^{(O)}32 [−1, 0, 0, 0, 0, 0, 0, 0, 0, 0, 1] and sₖ^{(M)}=[1, 0, 0, 0, −1] is able to approximately get the energy ratio between the middle two lobes and outer two lobes of a DPP CSR. Note that the filter parameters in the example have been set for 25 GB Blu-ray Disc, but have to be adjusted for the specific read-out channel. When Δχ is larger than a preset threshold, instead of a radial tilt a tracking offset is identified and no tilt correction will be executed.

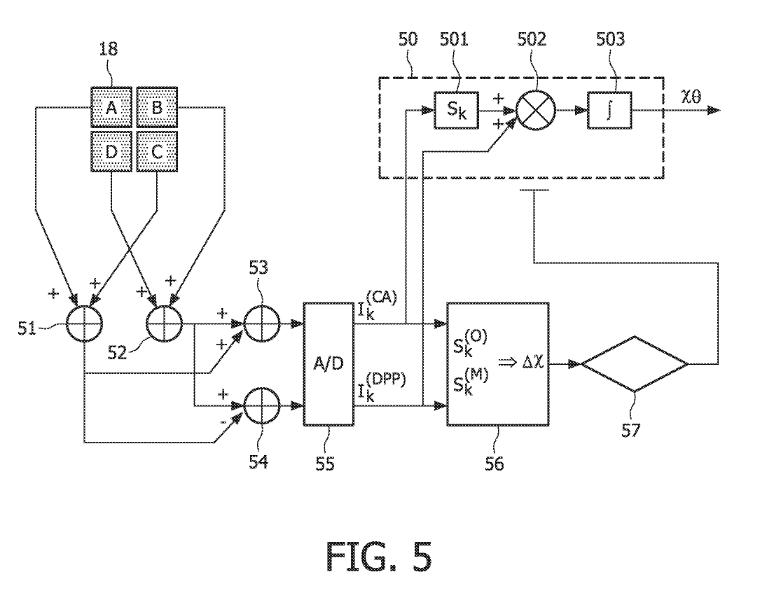

FIG. 5 shows a tilt signal generating device. The Figure shows a schematic drawing of a possible tracking and tilt discrimination circuit implementation according to the discrimination of tilt and tracking errors described above. A detector 18 has four sub-detectors A, B, C and D for generating sub-detector signals S_{A} to S_{D}. Signals S_{A} and S_{C} are added by adder 51, and signals S_{B} and S_{D} are added by adder 52, the added signals are added by adder 53 to generate a read signal, usually called central aperture signal I_{CA}. The added signals are subtracted in subtraction unit 54 to generate the diagonal push-pull signal S_{DPP}=S_{A}+S_{C}−S_{B}−S_{D}. The combined signals are converted to digital signals Iₖ^{(CA)} and Iₖ^{(DPP)} in analog to digital converter 55, as a function of scanning position k. It is to be noted that the processing assumes that the scanning position k corresponds to a time period k based on a clock that is synchronized with the data marks in the track, which is common in circuits for digitally processing readout signals. Alternatively the calculation may be adapted to take into account a misalignment of the period k and the channel bit clock of the marks read from the data track on the record carrier.

The digital signals are processed in a tilt calculation unit 50 for generating a tilt signal χ_{θ}. The tilt calculation unit 50 includes a channel response unit 501 having a response function sₖ as described above for generating the channel data signal based on the read signal Iₖ^{(Ca)} representing data from the data track convoluted with the response function sₖ. In calculation unit 502 the channel data signal is multiplied with the diagonal push-pull signal Iₖ^{(DPP)}, and the result is integrated in integrating unit 503 to generate the tilt signal χ_{θ} as described above.

The tilt signal generating device may include a tilt discrimination unit 56 for processing the digital signals Iₖ^{(CA)} and Iₖ^{(DPP)} for generating a tilt discrimination signal χ_{θ}, for example based on formula (8) above. A tilt judging unit 57 compares the tilt discrimination signal Δχ with a predetermined threshold and generates a tilt control signal for activating the tilt calculation unit 50. The output of the tilt judging unit 57 acts as an enabling signal for the tilt estimation. When the output is “N”, χ_{θ} is set to zero. Additionally a tracking servo may be activated to correct the position of the scanning spot with respect to the center of the track.

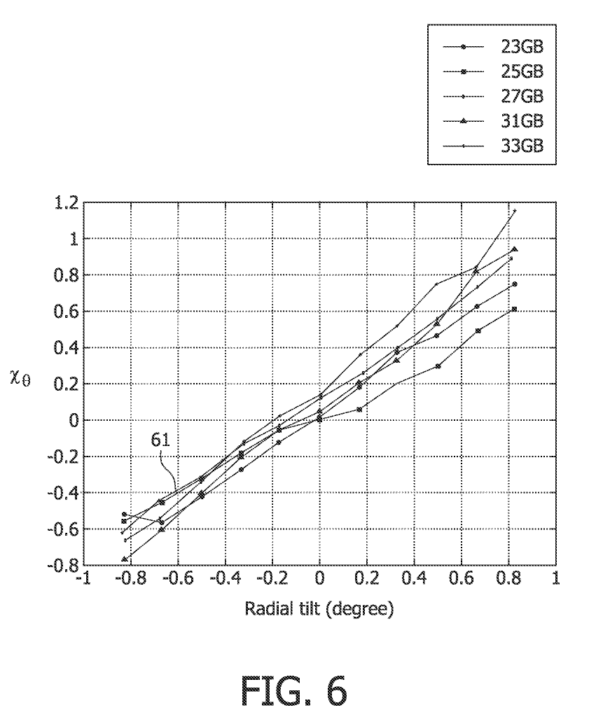

FIG. 6 shows radial tilt estimation results. The Figure shows a set of curves 61 for different optical record carriers, e.g. Blu-ray Discs having a data capacity between 23 Gb and 33 Gb as indicated in the Figure. The horizontal axis indicates a range of tilt values between −1 and +1 degrees of radial tilt; the vertical axis shows the tilt signal.

In the simulation, four quadrant data signals of a BD disc are measured from a BD experimental tester with various radial tilt settings and then processed according to Equation (7) to get the tilt estimate. The results are shown in FIG. 6. One can see that the estimate is nicely a linear function of the actual radial tilt angle and therefore may be used, for example, as an error measure for an electronic or mechanical radial tilt corrector.

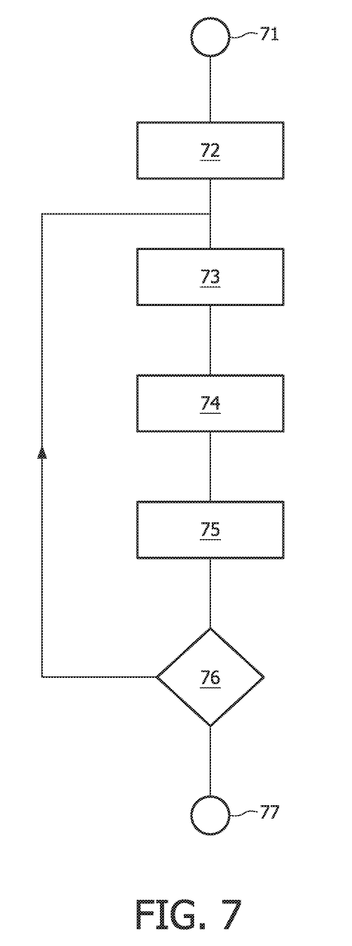

FIG. 7 shows a process of detecting tilt. A tilt detecting process is started at node START 71. A record carrier is inserted at node INSERT DISC 72, and an initial startup routine is performed, e.g. including moving a scanning head to an initial position and activating a rotation motor and servo system for rotating the record carrier. The scanning of tracks on the record carrier is activated in node SCAN 73. In next node GENERATE DPP 74 a diagonal push-pull signal is generated from sub-detector signals as explained above. In step PROCESS 75 the diagonal push-pull signal is processed to generate the tilt signal, e.g. filtered to isolate and amplify the tilt related signal components in the diagonal push-pull signal. Suitable formulas for processing have been explained above, e.g. formula (7) based on the synchronous central aperture signal. In step DETECT TILT 76 the tilt signal that has been generated is judged. If tilt is present, a corrective action may be started, or the tilt that has been detected may be used to improve the signal processing for the data readout signal. The process continues at the node SCAN 73, or is terminated at node END 77 when no further access to the record carrier is required, e.g. by the user giving an eject command.

Although the invention has been mainly explained by embodiments using BD optical discs, the invention is also suitable for other record carriers such as rectangular optical cards, magneto-optical discs, multilayer high-density discs or any other type of information storage system that has a tilt sensitive scanning system.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for scanning an optical record carrier (11), the record carrier comprising a data layer having substantially parallel data tracks, the device comprising:
an optical head (22) comprising a detector for receiving radiation reflected from a data track, the detector having sub-detectors arranged in a quadrant aligned in a direction corresponding to the track direction, and
tilt means (32) for generating a tilt signal representing a tilt angle between an optical axis of the optical head and a perpendicular of the data layer,
the tilt means (32) being arranged for
generating a diagonal push-pull signal based on a difference of a first signal of a first diagonally positioned pair of sub detectors and second signal of a second diagonally positioned pair of sub detectors, and
processing the diagonal push-pull signal for generating the tilt signal.

2. Device as claimed in claim 1, wherein the tilt means (32) are arranged for generating the diagonal push-pull signal based on the formula
Iₖ^{(DPP)}=Iₖ^{(A)}+Iₖ^{(C)}−Iₖ^{(B)}−Iₖ^{(D)}
where Iₖ^{(X)} (X=A, B, C and D) denotes a radiation intensity on each sub-detector as a function of scanning position k, the first signal of the first diagonally positioned pair of sub detectors A, C being denoted by Iₖ^{(PP1)}=Iₖ^{(A)}+Iₖ^{(C)}, and the second signal of the second diagonally positioned pair of sub detectors B, D being denoted by: Iₖ^{(PP2)}=Iₖ^{(D)}+Iₖ^{(B)}.

3. Device as claimed in claim 1, wherein the tilt means (32) are arranged
for generating a channel data signal based on data from the data track and a channel response of a diagonal push-pull channel, and
for processing the diagonal push-pull signal by cross-correlating the diagonal push-pull signal and the channel data signal for generating the tilt signal.

4. Device as claimed in claim 3, wherein the tilt means (32) are arranged for generating the channel data signal based on the formula
Cₖ^{(DPP)}=(a*h^{(DPP)})ₖ
where aₖ represents a channel data sequence, and hₖ^{(DPP)} represents the channel response of the diagonal push-pull channel, and * represents a linear convolution, as a function of scanning position k.

5. Device as claimed in claim 4, wherein the tilt means (32) are arranged for generating the tilt signal χ_{θ} based on the formula
$${χ}_{θ} = {\sum }_{k} ( {( a * {h}^{( DPP )} )}_{k} \times {I}_{k}^{( DPP )} )$$
which cross-correlates the diagonal push-pull signal Iₖ^{(DPP)} with the channel data signal (a*h^{(DPP)})ₖ, as a function of scanning position k.

6. Device as claimed in claim 3, wherein the tilt means (32) are arranged for generating the channel data signal by convolving an estimated bit sequence âₖ with a filter having an impulse response sₖ corresponding to the channel response hₖ^{(DPP)} as a function of scanning position k, and generating the tilt signal χ_{θ} based on the formula
$${χ}_{θ} = {\sum }_{k} ( {( \hat{a} * s )}_{k} \times {I}_{k}^{( DPP )} )$$

7. Device as claimed in claim 3, wherein the tilt means (32) are arranged for generating the channel data signal by convolving a data read signal with a filter having an impulse response sₖ corresponding to the channel response hₖ^{(DPP)} as a function of scanning position k, in a particular case the data read signal being a central aperture signal Iₖ^{(CA)} and generating the tilt signal χ_{θ} based on the formula
$${χ}_{θ} = {\sum }_{k} ( {( {I}^{( CA )} * s )}_{k} \times {I}_{k}^{( DPP )} )$$

8. Device as claimed in claim 1, wherein the tilt means (32) comprise discrimination means (34) for generating a difference signal for discriminating a tracking offset from a tilt based on
the diagonal push-pull signal cross-correlated with a data read signal convolved with a first filter having a first impulse response based on the channel response of a diagonal push-pull channel in the event of tilt, and
the diagonal push-pull signal cross-correlated with a data read signal convolved with a second filter having a second impulse response based on the channel response of the diagonal push-pull channel in the event of tracking offset.

9. Device as claimed in claim 8, wherein the discrimination means (34) are arranged for, using a central aperture signal Iₖ^{(CA)} as the data read signal, generating the difference signal Δχ based on the formula
$$Δχ = \vert \vert {\sum }_{k} ( {( {I}^{( CA )} * {s}^{( O )} )}_{k} \times {I}_{k}^{( DPP )} ) \vert - \vert {\sum }_{k} ( {( {I}^{( CA )} * {s}^{( M )} )}_{k} \times {I}_{k}^{( DPP )} ) \vert \vert$$
the first impulse response s^{(O)}ₖ corresponding to outer lobes in the channel response for a data symbol as a function of scanning position k, and
the second impulse response s^{(M)}ₖ corresponding to inner lobes in the channel response for a data symbol as a function of scanning position k.

10. Method of detecting tilt while scanning an optical record carrier (11), the record carrier comprising a data layer having substantially parallel data tracks, the method comprising:
generating a tilt signal representing a tilt angle between an optical axis of the optical head and a perpendicular of the data layer based on radiation reflected from a data track received on sub-detectors arranged in a quadrant aligned in a direction corresponding to the track direction,
generating a diagonal push-pull signal based on a difference of a first signal of a first diagonally positioned pair of sub detectors and second signal of a second diagonally positioned pair of sub detectors, and
processing the diagonal push-pull signal for generating the tilt signal.
